(19) United States
(12) Patent Application Publication
(10) Pub. No.: US 2015/0012355 A1
(43) Pub. Date: Jan. 8, 2015

(54) METHOD OF ADVERTISING BY USER PSYCHOSOCIAL PROFILING

(71) Applicant: SenseGon Technologies Ltd., Ra'anana (IL)

(72) Inventors: Omer EFRAT, Tel Aviv (IL); Tal YAARI, Bnei-Brak (IL)

(21) Appl. No.: 13/933,258

(22) Filed: Jul. 2, 2013

(51) Int. Cl. G06Q 30/02

(52) U.S. Cl. CPC G06Q 30/0254
USPC 705/14.52

(57) ABSTRACT

Profiling based advertising and commerce systems are provided herein. The system statistically analyzes user activity data of social network users and normalizes the statistical data with respect to specified user populations. Then the system profiles each user with respect to user archetypes using empirical study data that correlates the user archetypes with respective normalized statistical activity data relating to the user. The correspondence analysis is carried out by applying a heuristic genetic algorithm on an artificial neural network that represents the relation between the normalized user study data and the user archetypes. Profiles and segmentations produced are used for designing advertising campaigns and electronic commerce.

### BACKGROUND OF THE INVENTION

1. Technical Field

The present invention relates to the field of advertising, and more particularly, to directed advertising that uses extensive user profiling.

2. Discussion of Related Art

Web-based advertising faces the challenge of accurately directing appropriate ads to corresponding users. Using user interactions to characterize and profile the users is not sufficiently developed to enable such efficient advertising.

### BRIEF SUMMARY OF THE INVENTION

One aspect of the present invention provides a system comprising a profiling unit comprising a statistical module arranged to receive user activity data and derive therefrom a plurality of statistical data that characterize the user activity data with respect to a plurality of users; a normalization module arranged to normalize the statistical data related to each user with respect to at least one user population; and an analysis unit arranged to analyze a correspondence between a plurality of normalized user study data and a plurality of user archetypes, and to associate, for each user, the normalized statistical data with one of the user archetypes according to the analyzed correspondence. The correspondence analysis is carried out by applying a heuristic genetic algorithm on an artificial neural network that represents the relation between the normalized user study data and the user archetypes. The system further comprises an application interface to at least one social network platform arranged to obtain the user activity data therefrom and provide the obtained user activity data to the statistical module; and a profiling interface arranged to present the association of users and user archetypes carried out by the analysis unit.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIGS. 1 and 3 are high level schematic block diagrams illustrating a profiling system according to some embodiments of the invention,

FIG. 2 is a high level schematic illustration of the information flow through a profiling system according to some embodiments of the invention,

FIG. 4 is a high level schematic illustration of an advertising system according to some embodiments of the invention,

FIG. 5 is a high level schematic illustration of a query generator according to some embodiments of the invention, and

FIG. 6 is a high level schematic flowchart of a profiling method according to some embodiments of the invention.

### DETAILED DESCRIPTION OF THE INVENTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

Certain embodiments of the invention comprise profiling based advertising and commerce systems. The system statistically analyzes user activity data of social network users and normalizes the statistical data with respect to specified user populations. Then the system profiles each user with respect to user archetypes using empirical study data that correlates the user archetypes with respective normalized statistical activity data relating to the user. The correspondence analysis is carried out by applying a heuristic genetic algorithm on an artificial neural network that represents the relation between the normalized user study data and the user archetypes. Profiles and segmentations produced are used for designing advertising campaigns and electronic commerce.

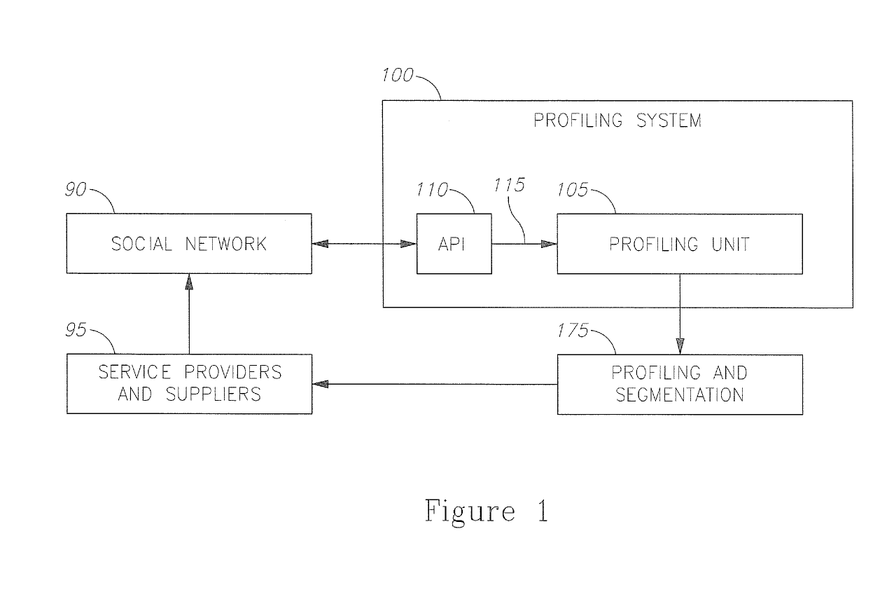

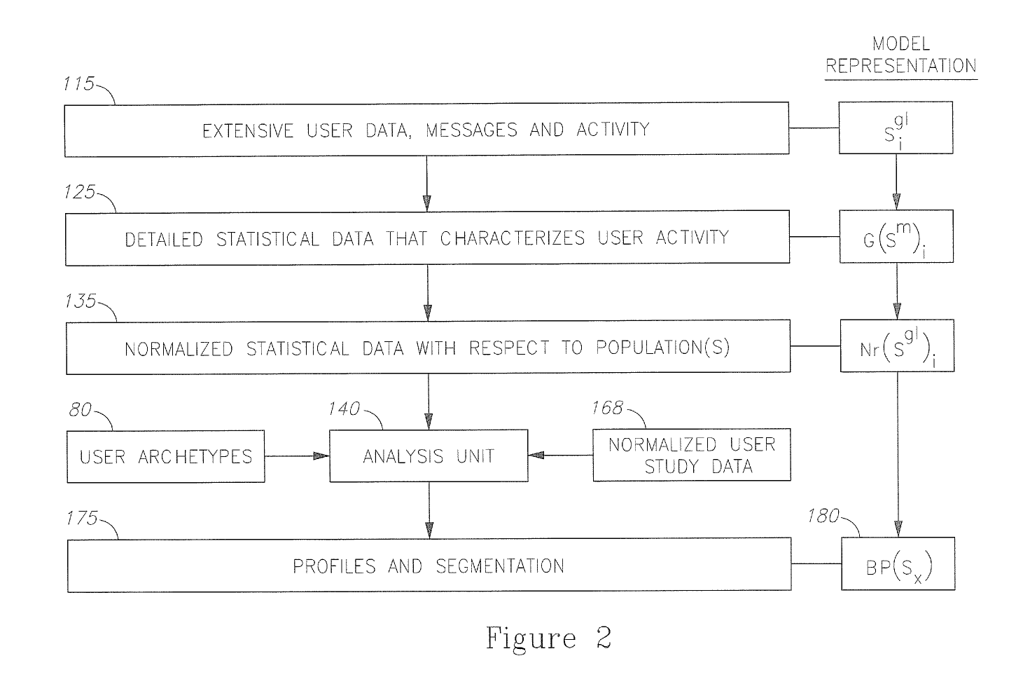

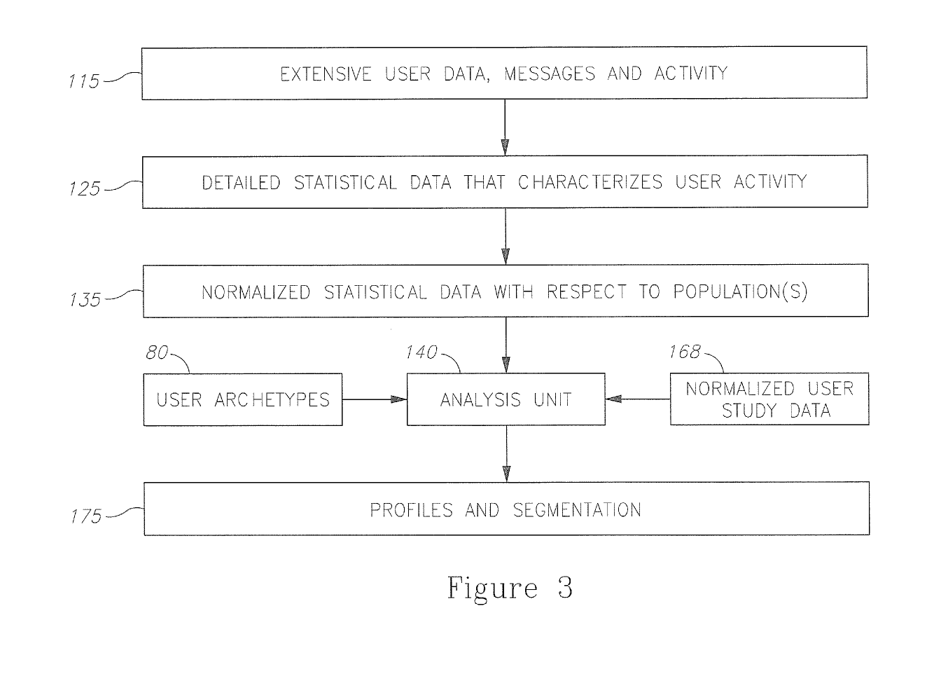

FIGS. 1-3 are high level schematic illustrations of a profiling system 100 according to some embodiments of the invention. FIGS. 1 and 3 are high level block diagrams, while FIG. 2 illustrates the information flow through the system. Profiling system 100 may be at least partially implemented in computer hardware.

Profiling system 100 comprises a profiling unit 105 arranged to receive extensive user data 115, messages by users and user activities from various internet sources such as social networks 90, groups and forums and other sources, via an application programming interface (API) 110 which is dedicated to retrieve extensive data 115 from the relevant platforms. API 110 is also termed sniffer or super sniffer to denote its retrieval capabilities.

Profiling unit 105 comprises a statistical module 120, a normalization module 130 and an analysis unit 140, either of which may be at least partially implemented in computer hardware.

Statistical module 120 is arranged to receive user activity data 115 via API 110 and derive therefrom a plurality of statistical data 125 that characterize user activity data 115 with respect to a plurality of users, e.g. of social network 90. Statistical data 125 may be extensive and relate to various metrics, forms and ways of quantifying user activity data 115 such as counting messages, counting message lengths, assessing the vocabulary used, message complexity, number of corresponding users, duration of engagement in conversation, use of certain words or word categories, inter-relations between messages etc. See further details below.

In the model formalization, user activity data 115 is represented as Sᵢ^{gl} (FIG. 2). S is a basic discrete accumulated identifier. Examples for S comprise a wide range of parameters, for example, a number of messages for week, a number of friend request, a number of stated conversations, a number of published posts, and so forth. The index gl denotes the organic object current aggregation level. Examples of aggregation levels may comprise self-user, contact user, close environment, demographic environment, etc. The index i denotes the organic data entity instance. Examples of organic data entity instances may comprise specific monitored user, a specific contact user, etc.

In the model formalization, statistical data 125, also termed gross data, is represented as G(S^{m})ᵢ=Tₜ<G(S^{k . . . l})_{m . . . n}>. G(S) is a basic gross identifier. Examples of basic gross identifiers comprise e.g. daily average message per contact user, yearly engaged users, sum of received massages, average rate of conversation initializations etc. T represents a linear transformation type such as sum, average, count, variance, etc.

Normalization module 130 is arranged to receive and normalize statistical data 125 related to each user with respect to at least one user population to yield normalized statistical data 135 with respect to the population(s). The referred population may comprise all users of social network 90 or comprise sub-groups of users such as correspondents of each user, friends of the user, users having similar characteristics or similar to the user under specified rules etc. Normalization module 130 generates normalized statistical data 135 that characterizes each user and is simultaneously comparable between users due to its normalization.

In the model formalization, normalized statistical data 135 is represented as

Nr(S^{gl})ₜ=fNr<G(S^{gl})ᵢ,Tᵥₐᵣ<G(S^{gl+m})_{1 . . . k}>,T_{avg}<G(S^{gl+m})_{1 . . . k}>>

Nr(S) is a relative normalized gross identifier. Nr values are between 0 to 1 as they are normalized with respect to a whole population. The relative normalized gross identifiers represent the user's grade in each of his gross identifiers G(S), relative to his dynamic environment. m is an aggregation level indicator, wherein the selected level must be equal or greater than the current level).

Analysis unit 140 is arranged to analyze a correspondence between a plurality of normalized user study data 168 and a plurality of user archetypes 80. User archetypes 80 may be pre-defined according to socio-psychological criteria, and user study data 165 may be based on socio-psychological studies 165 such as profiling studies and verification studies which are externally managed to yield effective profiling and archetype analysis.

Analysis unit 140 is further arranged to associate, for each user, normalized statistical data 135 with one of user archetypes 80 according to the analyzed correspondence between normalized user study data 168 and user archetypes 80. The correspondence analysis yields profiling and segmentation data 175 of the users, which may be used for different aims such as advertising and e-commerce, that may be operated by various service providers and suppliers 95, optionally but not necessarily in relation of social network 90 from which user data have been collected.

In the model formalization, profiling and segmentation data 175 of the users is represented as Behavioral Pattern (BP) identifiers BP(Sₓ) 180. Examples for BP identifiers comprise, for example, practical, achiever, emotional, status seeker, popular, risk avoider, explorer, persistent, etc. x denotes a specific user instance.

Calculation of BP's 180 from normalized statistical data 135 represented as Nr's is carried out according to the following expression:

$${BP}_{x} = [ \frac{{\sum }_{i = 1}^{n} {ω}_{i} {Nr}_{i} - {\sum }_{j = n + 1}^{m} {ω}_{j} {Nr}_{j} + {\sum }_{j = n + 1}^{m} {ω}_{j}}{{\sum }_{k = 1}^{m + n} {ω}_{k}} + {\sum }_{d = 1}^{h} {ω}_{d} {Nr}_{d} * \frac{{ω}_{d}}{y} - {\sum }_{c = 1}^{l} {ω}_{c} {Nr}_{c} * \frac{{ω}_{c}}{y} ] \begin{matrix}1 \\ 0\end{matrix}$$

The symbols used denote: n—Number of positive effect vector parameters; h—Number of positive effect vector only parameters; m—Number of negative effect vector parameters; I—Number of negative only effect vector parameters; y—Fixed number which indicates the effect of a specific Nr on the formula and ωᵢ denote the weights.

The correspondence analysis may be carried out by applying a heuristic genetic algorithm (GA) on an artificial neural network (ANN) that represents the relation between normalized user study data 168 and user archetypes 80. Analysis unit 140 may comprise a modeller 170 arranged to represent normalized statistical data 135 as the artificial neural network, a profiling module 150 arranged to apply the heuristic genetic algorithm on the artificial neural network represented by modeller 170, and a trainer 160 arranged to train profiling module 150 with obtained normalized user study data. The analysis may be carried out by a profiling module 150 operating on an ANN model generate by a modeller 170. Normalized user study data 165 may be used to train the heuristic genetic algorithm via trainer 160.

The GA is a key feature which operates at the core of the behavioral identification technology to derive human personality analysis from online psycho-social behavior. The GA performs a behavioral psychological analysis of online communications and other interactions over time in order to identify and classify human behavior patterns. The GA is architecturally designed to operate independently from applicative layers and uses a broad data layer that is retrieved from social networks and is referred to as user activity data 115 representing social interactions data.

In certain embodiments, the social interactions data (user activity data 115) may be divided into four sub-layers. The first and basic one is the basic demographic layer (as explained), the next three micro-layers are composed of sophisticated formative gross data retrieved from the user's social interactions across the social network. Gross data (user activity data 115) is manipulated into various types of measures such as sums, averages, variances etc. to yield detailed statistical data that characterizes user activity 125. Detailed statistical data 125 is then normalized in comparison with the user's different environments and relationship circles: peer group, same gender same age group, close friends, all contacts etc. to yield normalized statistical data 135. This normalization process enables the GA to detect the relative location of the user on the scale of a specific behavior pattern and so forth to formulate his personality profile and clustering.

In certain embodiments, examples for social interactions data (user activity data 115) may comprise user's basic demographic information (such as the user's birth date, gender, place of residence, homeland, education, work etc.), interpersonal interaction data, public interaction and user to group interactions. The latter three examples are illustrated below in a non-limiting manner.

Interpersonal interaction is an interaction level which includes all relevant data that can be gathered from users' chats and/or offline messages. The GA collects the patterns and formative characteristics of correspondences which indicate the overall behavior pattern of the user's relationships and hence the user's personality across time and contacts. Gross interpersonal data may comprise data relating to relationships, conversations, messages, missed calls, sequences of messages, words, punctuation marks, chars repetition, common hours of interaction, initiation and duration of interaction, in addition to specific vocabulary. The activeness and conversation pattern of the user may be measured by comparison to his interlocutors.

Public interaction is an interaction level which comprises the user's public posts and/or public responses etc. Public interaction gross data may comprise statuses, photos, albums, shared links, comments, likes, statements of interests and hobbies, like indications, applications activity etc. Common measures of these data may comprise amount, frequency, length and category distribution. The user may be measured compared to his responders and/or other users discussing within the same post.

User to group interactions relates to analyzed user behavior in public circles which include his contacts users and outsider users. The GA gathers information regarding the user's “spreading the word” abilities distribution relativity, leading abilities relativity, frequency of user's contacts circle growth.

In certain embodiments, profiling and segmentation data 175 of the users may be used for different aims such as advertising and e-commerce. For example, an advertisement managing unit may be arranged to generate advertisements relating to user archetypes 80 and a campaign managing unit may be arranged to present the generated advertisements to users of e.g., a social network platform according to their association with user archetypes 80. In another example, a proposal generator may be arranged to generate commercial proposals relating to user archetypes 80 and a commerce manager may be arranged to present the generated commercial proposals to users of, e.g., a social network platform according to their association with user archetypes 80. The commerce manager may be further arranged to manage electronic commerce of the users in relation to their associated user archetypes 80.

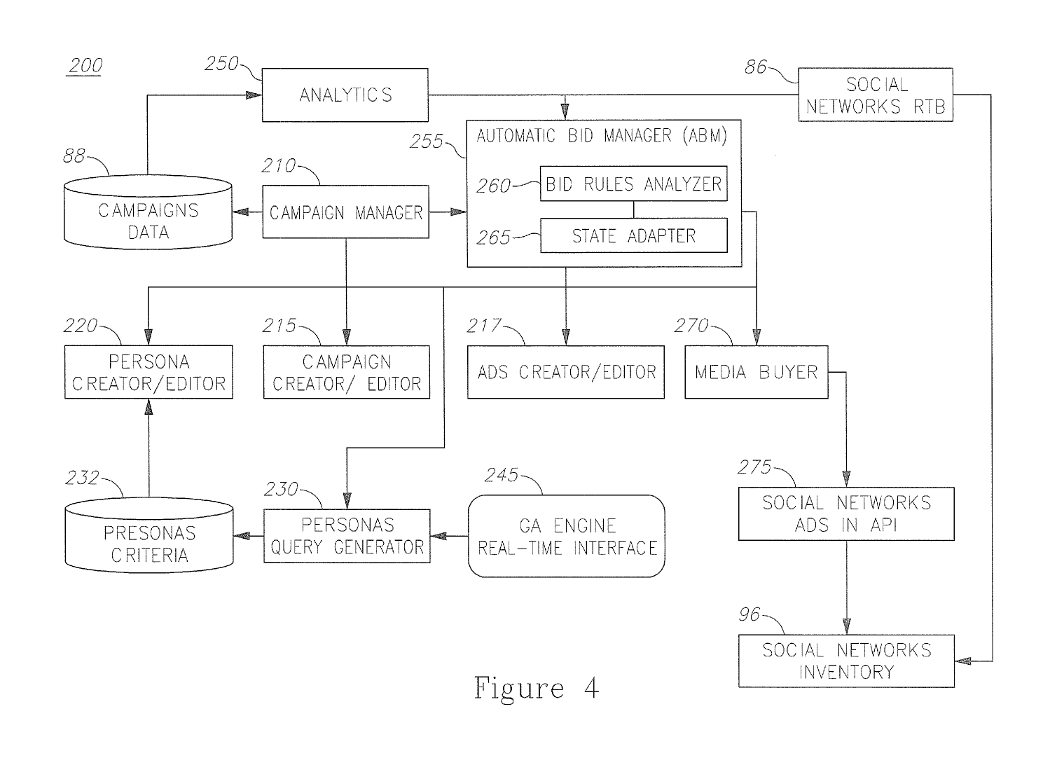

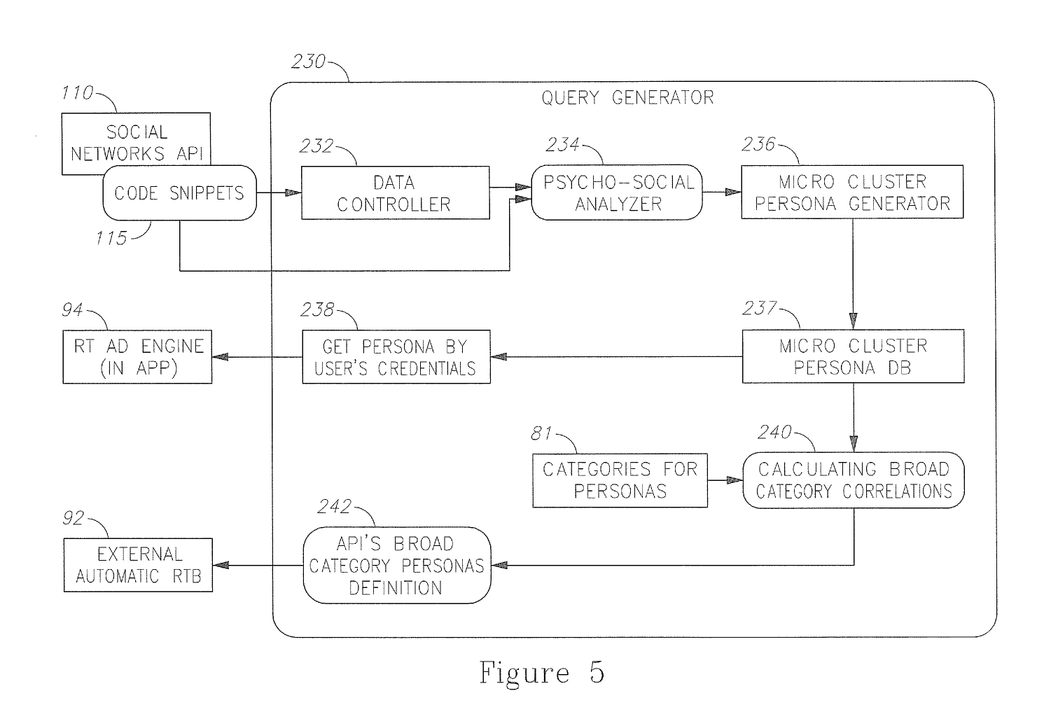

FIG. 4 is a high level schematic illustration of an advertising system 200 according to some embodiments of the invention. Advertising system 200 may be modified to function as an e-commerce system, as explained below. Advertising system 200 may be at least partially implemented in computer hardware.

Advertising system 200 may be connected to a social-network ads inventory through a public ad interface, wrapping or directly using its infrastructures (with a direct API). In embodiments, advertising system 200 implements the following conceptual steps. First, system 200 allows an advertiser to define raw demographic characteristics of the campaign's target audience, based on the product's and/or campaign's designation. For example, demographic characteristics may comprise age range, gender, place of residence (e.g. up to the specific city resolution) etc. A campaign creator and editor 215 may allow using these raw demographic characteristics for carrying out a basic segmentation of users of, e.g., a social network. A campaign creator and editor 215 may enable creating and editing campaigns; provides segmentation parameters such as: product category, ages range, gender, interests, etc. These parameters define each campaign and are editable whenever it is required.

Then, system 200 creates persona which are defined as combinations of user archetypes 80. A persona creator and editor 220 may adapt the personas definitions and creates ads that are aimed at each persona. Each archetype 80 in system 200 represents a specific behavioral pattern of the social network user and the desired potential customer. In an example, a single persona may include up to three archetypes out of an optimized inventory. Archetypes may refer to both or either comprehensive psycho-social personalities as well as to the user's particular consuming behavior. A single product can be designated to specific personalities while excluding others, based on market research, or it can be designated to reach all categories of personalities. Using the persona creating process (see below), the advertiser can define and alter the archetypes composing his campaign's personas. Persona creator and editor 220 may be responsible for defining audience figures known as personas. It displays the different archetypes 80 which compose a persona. Each created/edited persona may be assigned to a specific campaign.

Finally, system 200 creates and alters ads by an ads creator and editor 217. Ads may be designed and tailored to each specific persona, based on the archetypes it is composed of. All archetypes 80 are specified and detailed within system 200 next to the recommended form of approach that would reach the specific personality attention and engagement. Each creative should send the suited message to the potential customer's psycho-social thinking and behavior, based on the chosen archetypes. All or most of the ad's features (picture, headline and ad's body) may be engaged with the precise character of the user individually and all together. Ads creator and editor 217 may comprise a design platform. During the design process, it may display the ad's preview as an indicator of the ad's visual display as it will be published over the social network pages. In addition, ads creator and editor 217 may enable to define the daily budget and ad's max bid.

Advertising system 200 comprises a campaign manager 210 that is arranged to enable advertisers (and any other kind of media buyer) to dynamically manage online advertising campaigns. Thus, campaign manager module 210 displays a general overview about each campaign and provides a real time map of all campaigns (stored, e.g., in campaigns database 88). The real time map may comprise the last activities and changes made within each campaign, divided chronologically by date and time, which enables the user to follow his own actions (campaign/persona/ad creating, creative changes, budget changes etc.) as well as actions carried out by advertising system 200 (e.g., ads approvals, recent spent etc.), campaign overall raw performance data (reach, total clicks, CTR, etc.) Campaign manager module 210 may further display campaign advanced data including the improvements of performance made by advertising system 200 in comparison with the market benchmark. Campaign manager module 210 may further display analytical charts and figures for visual impression, presentation and concluding. Analysis may be carried out by an analytics module 250. The hierarchy of campaign manager module 210 may begin with the campaign objects, continue with persona objects and end with ad objects. Each level enables managing the campaign in a different resolution by specifying the specific object's activities, performance and analytics.

Data from campaign manager module 210 is used to generate persona queries by a query generator 230. FIG. 5 is a high level schematic illustration of query generator 230 according to some embodiments of the invention.

Query generator 230 receives user activity data 115 via API 110, e.g., as code snippets. A data controller 232 publishes an invoke for the asynchronous data retrieving process, as part of API 110 (e.g., a super sniffer) that gathers new data. Data controller 232 thus ensures up- to-date user activity data 115 that is delivered to a psycho-social analyzer 234, which is a background process which performs the behavioral psychological analysis based on the social interactions data in user activity data 115. This process may operate asynchronous in background and be run continuously. Psycho-social analyzer 234 may actually run the GA's analysis processes as part of analysis unit 140. The results of the psycho social analysis (e.g., using the GA analysis process) are used by a micro cluster persona generator 236 to segment and create different micro clusters from the base segment (as defined in the father campaign), which are termed personas. As explained above, the personas are composed by combinations of archetypes resulted from the GA's analysis process.

Micro-clustering may be carried out by collecting raw data from the user throughout the social network to which he is connected (defined as a group P). The GA-mechanism takes each user in group P and creates for each one a compatible persona, by taking into consideration the best three archetypes 80 which best defines its behavioral pattern (BP's). As a result, these users in P can be divided to several user groups (Pa, Pb, etc.). Each persona in each group is being segmented by the following data: demographic (gender, age), geographic (city, state), interests (for example: sports, music, art), etc. As a result, each group is being divided to several groups with common characteristics.

These personas are used as an input for the advertisement process on which the ads are targeted correlated to their characteristics. Based on these results, micro cluster personas are saved in database 237. Users may be referred to as being part of their micro-cluster by a retrieval module 238 arranged to display an ad (e.g., via a realtime ad engine 94 in the application such as a social network) to a user based on specific users' credentials. The user's micro-cluster is selected from personas DB 237 and a specific ad which was targeted to him, will be displayed on his social network pages when he is logged in. The direct user display is performed by connecting to the social network API and is possible in networks which provide a direct access to the users. Realtime ad engine 94 may be associated with an automatic bid manager 255 (FIG. 4) as explained below.

In addition to the micro cluster persona generation, personas may also be categorized according to ad categories 81 by a broad category correlations calculating module 240. The users' behavioral data that is being used in the process of the GA can be processed in two deferent scales: (i) full audience analysis or (ii) sampled audience analysis. Using the full audience analysis is applicable when given access (by the hosting social network) to the entire advertiser's target audience basic segment (demographic characterized) users. Then, the GA creates the specific users groups, differentiates them by BPs (or archetypes 80) and empowers the advertisers to target them accordingly. In case that the hosting social network is limiting the users' data access or the direct user-groups targeting, system 200 may use a sampling methodology to define the BP groups.

The GA may sample the base-segment group and get a representing users group of each BP definition. Then, the GA may find the common characteristic of each group from the precise interests and broad categories layers (in case of using the Facebook engine) in order to match the sampled group to the full target audience. Module 240 thus defines a specific query (under a given basic segment) to each persona resulted from the GA's processes.

Calculated categories from module 240 may also be used to provide input to an external automatic real-time bidding RTB system 92 for dynamic, auction-based ads inventory management. API's broad category personas definitions 242 may be used to assist in publishing ads among groups of users who share the same queries and mostly being performed in social networks which doesn't give direct access to users. The definitions and calculated categories may be provided to external autonomic RTB 92 (e.g., operated by the social network) for dynamic, auction-based ads inventory management. In these cases, query generator 230 may also control the inventory buying process by media buyer 270 (FIG. 4). In case that the social network is managing its ads inventory using manual or direct buying and not with some auction-based module, an internal RTB in system 200 may expose the auction bidding layer to its users.

Referring back to FIG. 4, media buyer 270 is an automated background process which performs a real-time campaign uploading and editing by taking existing campaign's and ad's data from campaigns database 88. The uploading process is being performed by applying to a social network inventory 96 with a request to buy an impression on which the new campaign will be placed. Media buyer 270 applies to social network inventory 96 via a social networks inventory module 275 (possibly in API 110) which manages the advertisement impressions allocation to the users. Module 275 may operate a priority queue to which new campaign characteristics and bids (received from Mmdia buyer 270) are inserted. Then, by inner set of rules on which social networks inventory module 275 is based on, it prioritizes the campaigns in its queue and places the ad display.

System 200 may further comprise a GA Engine Real-time Interface 245 connected to analysis unit 140 that runs the GA as the key feature of the behavioral identification technology. During its runtime, it differentiates group of users to archetypes 80. These archetypes compose personas which are being used by system 200 in order to target different ads to different users.

Campaign data stored by campaign manager 210 in campaigns database 88 may be analyzed by an analytics module 250 to track and monitor the campaign, the generated ads and their association with personas and users. Analytics module 250 may further provide real time statistics regarding the campaign, the generated ads and their association with personas and users. Analytics module 250 may display crucial graphs such as click-through rate (CTR), daily spent budget, reach-clicks-leads etc. In addition, analytics module 250 may be arranged to enable defining dynamic reports on the advertiser's demand. In other words, each advertise can choose parameters to display in reports by demand. Analytics module 250 may report to a realtime bidding (RTB) engine 86, e.g., of system 200 or of external platforms such as social networks.

In certain embodiments, system 200 may further comprise an automatic bid manager (ABM) 255, which is a real time bidding system responsible for analyzing and adapting bids from media buyers 270 in uploaded campaigns according to pricing bids and analytics data. ABM 255 may comprise a bid rule analyzer 260 that analyzing sets of given rules and a state adapter 265 that performs campaign adoptions according to results from bid rule analyzer 260, as explained below.

Bid rule analyzer 260 as a core engine of ABM 255, analyzes the current ad's state using given sets of rules, analytics data and RTB pricing. For example, bid rule analyzer 260 may use analyzed RTB pricing data such as CPC—Cost per click, CPM—Cost per 1000 Impressions, CTR (Click through rate)—the proportion between the number of clicks and number of impressions, Base CTR—the reflected intersection point of the CPM and CPC as given by the social network RTB on the time of the campaign creation (relevant only for personas' ads). The Base CTR represents the updated online “market” price, for the exact target segment and its average CTR. Bid rule analyzer 260 may use further analyzed RTB pricing data such as Frequency—average number repetition that an ad was exposed to a unique user, Daily Budget—maximal amount of money to spend per day, Bid—the ad's price for impression and so forth.

State adapter 265 enables to respond dynamically in real time according to the market's movements. In order to do so, state adapter 265 compares the Base CTR against the actual CTR and performs the following actions: (i) Changes CPC/CPM bid method: In order to spend the budget optimally, state adapter 265 analyzes the relationship between the CTR and the Base CTR. Using the set of rules which relate to that analysis, state adapter 265 changes the bid method and bid value accordingly; (ii) Changes bid and daily budget values: bid and daily budget costs are playing an important role not only in the amount of money the advertiser spend, but also in the time it takes to get an approval for campaign upload. Thus, state adapter 265 calculates the break-even point between bid and daily budget which meet the social network bid and daily budget ranges, while taking into consideration the importance of keeping a low daily budget burn rate; (iii) Replaces/removes/re-targets ads: the proportion between the CTR and Base CTR indicates how effective the ads are. In case the proportion is low, state adapter 265 can decide whether to re-target the current ads, remove and replace ads and test their effectiveness in the next advertising session.

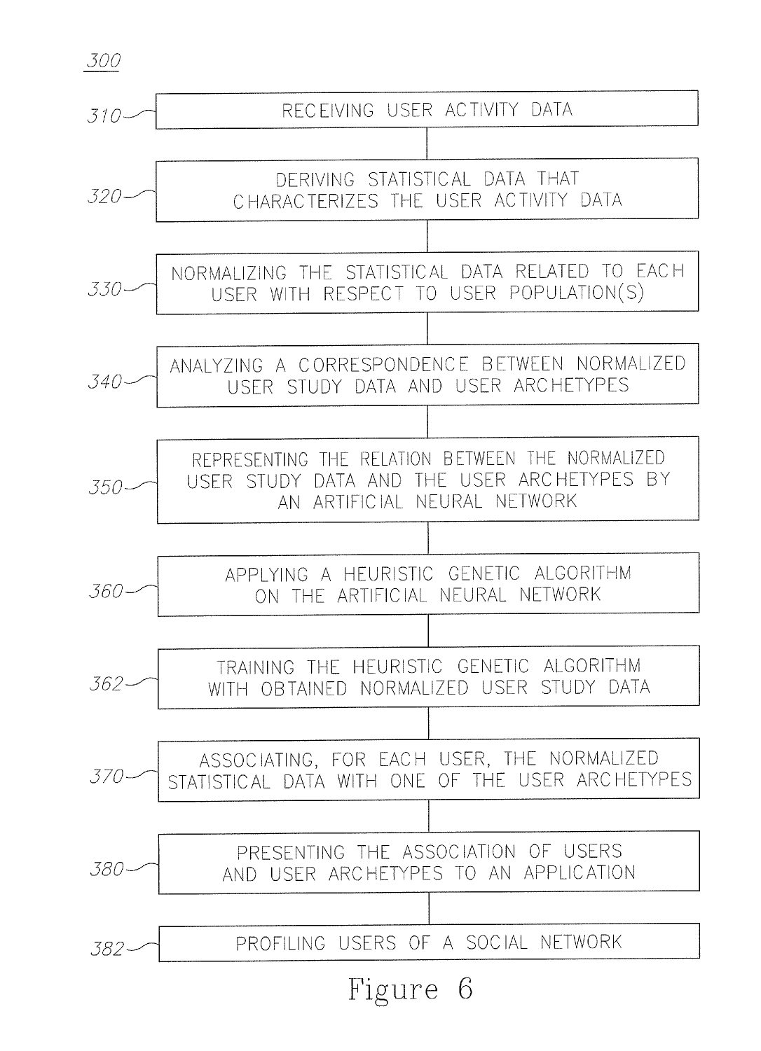

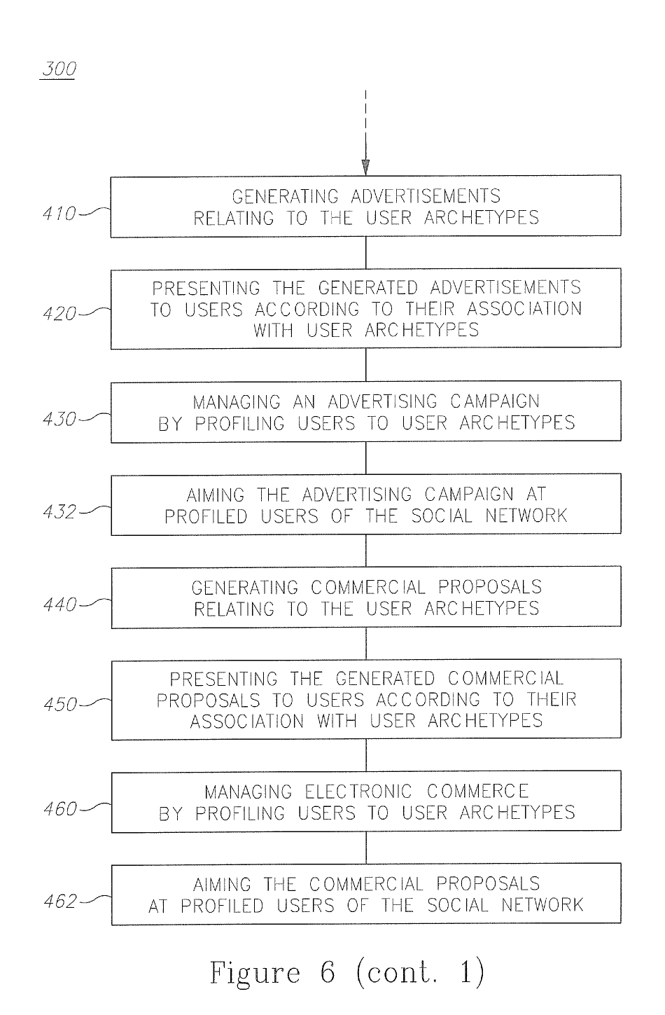

FIG. 6 is a high level schematic flowchart of a profiling method 300 according to some embodiments of the invention. At least one stage of method 300 is at least partially carried out by at least one computer processor.

Method 300 comprises the following stages: Receiving user activity data (stage 310); deriving statistical data that characterizes the user activity data (stage 320); normalizing the statistical data related to each user with respect to user population(s) (stage 330) and analyzing a correspondence between normalized user study data and user archetypes (stage 340).

Method 300 may further comprise representing the relation between the normalized user study data and the user archetypes by an artificial neural network (stage 350).

Analyzing the correspondence (stage 340) may comprise applying a heuristic genetic algorithm on the artificial neural network (stage 360); training the heuristic genetic algorithm with obtained normalized user study data (stage 362); and associating, for each user, the normalized statistical data with one of the user archetypes (stage 370).

Method 300 may further comprise presenting the association of users and user archetypes to an application (stage 380) and profiling users of a social network (stage 382).

In certain embodiments, method 300 may further comprise generating advertisements relating to the user archetypes (stage 410); presenting the generated advertisements to users according to their association with user archetypes (stage 420); and managing an advertising campaign by profiling users to user archetypes (stage 430). For example, method 300 may comprise aiming the advertising campaign at profiled users of the social network (stage 432).

In certain embodiments, method 300 may further comprise generating commercial proposals relating to the user archetypes (stage 440); presenting the generated commercial proposals to users according to their association with user archetypes (stage 450); and managing electronic commerce by profiling users to user archetypes (stage 460). For example, method 300 may comprise aiming the commercial proposals at profiled users of the social network (stage 462).

In certain embodiments, profiling system 100 may be used as an advertising management, targeting and media buying platform. Based on the behavioral psycho-social engine, profiling system 100 is arranged to provide a unique and simple way to plan, provision, and test and easily manage social networks ads campaigns.

Advantageously, profiling system 100 and method 300 may be designed for the direct users' engagement layer, mainly on social platforms, using display ads from social inventory. Profiling system 100 and method 300 take different types of raw data from social networks and based on the unique analytical processes, accurately differentiates the users by analyzing their psycho-social behavioral pattern. Therefore, marketing messages can be more finely-tuned and personally directed to each psychological persona type.

In addition to the current social network methods of providing advertisers with obvious data such as user's interests, groups, geographical location, etc., profiling system 100 and method 300 further delve into yet another layer of user information that determines users' personalities. Profiling system 100 and method 300 accurately map valuable data from multi-layered virtual communication in social networks and create users' personal, archetypes-based customer profile. Advantageously, profiling system 100 and method 300 target the exact human profile user group for personalized user engagement and may split campaigns using an accurate users' clustering—reaching every different customer type with a designated, relevant advertising massage.

In the above description, an embodiment is an example or implementation of the invention. The various appearances of “one embodiment”, “an embodiment”, “certain embodiments” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Certain embodiments of the invention may include features from different embodiments disclosed above, and certain embodiments may incorporate elements from other embodiments disclosed above. The disclosure of elements of the invention in the context of a specific embodiment is not to be taken as limiting their used in the specific embodiment alone.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A profiling system comprising:
a profiling unit comprising:
a statistical module arranged to receive user activity data and derive therefrom a plurality of statistical data that characterize the user activity data with respect to a plurality of users;
a normalization module arranged to normalize the statistical data related to each user with respect to at least one user population; and
an analysis unit arranged to analyze a correspondence between a plurality of normalized user study data and a plurality of user archetypes, and to associate, for each user, the normalized statistical data with one of the user archetypes according to the analyzed correspondence,
wherein the correspondence analysis is carried out by applying a heuristic genetic algorithm on an artificial neural network that represents the relation between the normalized user study data and the user archetypes,
an application interface to at least one social network platform arranged to obtain the user activity data therefrom and provide the obtained user activity data to the statistical module; and
a profiling interface arranged to present the association of users and user archetypes carried out by the analysis unit,
wherein at least one of the profiling unit, the application interface and the profiling interface is at least partially implemented in computer hardware.

2. The profiling system of claim 1, wherein the analysis unit comprises:
a modeller arranged to represent the normalized statistical data as the artificial neural network;
a profiling module arranged to apply the heuristic genetic algorithm on the artificial neural network represented by the modeller; and
a trainer arranged to train the profiling module with obtained normalized user study data.

3. The profiling system of claim 1, wherein the user activity data comprises at least one of: user data, user messages and user activity, related to user activity in at least one of: at least one social network and at least one internet forum or group.

4. The profiling system of claim 1, wherein the at least one user population comprises at least one of: all users, users within a group that is related to each user, correspondents of each user and users similar to each user under specified rules.

5. An advertizing system comprising:
the profiling system of claim 1;
an advertisement managing unit arranged to generate advertisements relating to the user archetypes; and
a campaign managing unit arranged to present the generated advertisements to users of the at least one social network platform according to their association with user archetypes.

6. An electronic commerce system comprising:
the profiling system of claim 1;
a proposal generator arranged to generate commercial proposals relating to the user archetypes; and
a commerce manager arranged to present the generated commercial proposals to users of the at least one social network platform according to their association with user archetypes.

7. The electronic commerce system of claim 6, wherein the commerce manager is further arranged to manage electronic commerce of the users in relation to their associated user archetypes.

8. A profiling method comprising:
deriving, from obtained user activity data, a plurality of statistical data that characterizes the user activity data with respect to a plurality of users;
normalizing the statistical data related to each user with respect to at least one user population;
analyzing a correspondence between a plurality of normalized user study data and a plurality of user archetypes by applying a heuristic genetic algorithm on an artificial neural network that represents the relation between the normalized user study data and the user archetypes;
associating, for each user, the normalized statistical data with one of the user archetypes according to the analyzed correspondence;
training the heuristic genetic algorithm with obtained normalized user study data; and
presenting the association of users and user archetypes to an application,
wherein at least one of: the deriving, the normalizing, the analyzing, the applying, the associating, the training and the presenting is carried out by at least one computer processor.

9. The method of claim 8, further comprising generating advertisements relating to the user archetypes and presenting the generated advertisements to users according to their association with the user archetypes.

10. The method of claim 9, further comprising managing an advertising campaign by profiling users of a social network according to the user archetypes and aiming the advertising campaign at the profiled users of the social network.

11. The method of claim 8, further comprising generating commercial proposals relating to the user archetypes and presenting the generated commercial proposals to users according to their association with the user archetypes.

12. The method of claim 11, further comprising managing electronic commerce by profiling users of a social network according to user archetypes and aiming the commercial proposals at the profiled users of the social network.
